(19) United States
(12) Patent Application Publication
(10) Pub. No.: US 2012/0148967 A1
(43) Pub. Date: Jun. 14, 2012

(54) CANDLE WICK INCLUDING SLOTTED WICK MEMBERS

(76) Inventor: Thomas J. Thomas, Summerville, SC (US)

(21) Appl. No.: 12/966,329

(22) Filed: Dec. 13, 2010

(51) Int. Cl. F23D 3/18; B23P 11/00

(52) U.S. Cl. 431/325; 29/428

(57) ABSTRACT

A candle wick (14) comprises a first wick member (16A) and a second wick member (16B). The first wick member (16A) includes a first slot (218A). The second wick member (16B) includes a second slot (218B). The second slot (218B) is engaged with the first slot (218A) so that the second wick member (16B) is engaged with the first wick member (16A) in an interlocking manner. The first wick member (16A) can be engaged at an angle with the second wick member (16B). The first wick member (16A) and the second wick member (16B) can be positioned at right angles or other than right angles relative to one another. Further, the first wick member (16A) includes a first wood material and the second wick member (16B) includes a second wood material. The first wood material can be substantially similar to the second wood material, or the first wood material can be different than the second wood material.

### BACKGROUND

Traditional candle wicks have been made from textile materials, such as cotton, linen, jute or hemp, most commonly in the form of a woven, braided, or twisted cord. Flat planar wicks of textile materials have also been used in candles.

More recently, wicks of thin planar strips of wood have been employed as candle wicks. While these simple wooden strips satisfy certain aesthetic design criteria, they also exhibit several technical limitations. Specifically, these planar wicks often fail to support a robust flame and thus are prone to self-extinguishing, especially during prolonged burn cycles. Further, the choice of wood for these strips is limited to only a few that perform satisfactorily. Similarly, these wicks are suitable only for narrowly defined wax fuel compositions. In addition, efficient manufacturing of various configurations of wooden wicks can be particularly challenging. For example, one-piece construction of different shaped wooden wicks can be difficult or impossible. Moreover, constructing multi-piece wooden wicks may involve the use of adhesives which can leach into the wax of the candle, affect the scent of the candle, and/or increase manufacturing complexity and production costs, among other disadvantages.

### SUMMARY

The present invention is directed toward a candle wick comprising a first wick member and a second wick member. The first wick member includes a first slot. The second wick member includes a second slot. Additionally, the second slot can be engaged with the first slot so that the second wick member is engaged with the first wick member in an interlocking manner.

Further, in certain embodiments, the first wick member includes a first wood material and the second wick member includes a second wood material. In some such embodiments, the first wood material is substantially similar to the second wood material. Alternatively, in other such embodiments, the first wood material is different than the second wood material.

In some embodiments, the first wick member is engaged at an angle with the second wick member. For example, in one such embodiment, the first wick member and the second wick member are positioned at right angles relative to one another. Alternatively, in other embodiments, the first wick member and the second wick member are positioned at other than right angles relative to one another.

In certain embodiments, the first wick member has a first height. In one such embodiment, the first slot extends substantially parallel to the first height. Somewhat similarly, in certain embodiments, the second wick member has a second height. In one such embodiment, the second slot extends substantially parallel to the second height.

Additionally, in one embodiment, the candle wick further comprises a third wick member including a third slot that is engaged at an angle with at least one of the first slot and the second slot. Moreover, in one embodiment, the candle wick further comprises a fourth wick member including a fourth slot that is engaged at an angle with at least one of the first slot, the second slot and the third slot.

Further, the present invention is directed toward a candle including a candle body and the candle wick as described above that is positioned substantially within the candle body.

Additionally, the present invention is further directed toward a method of manufacturing a candle wick and a method of manufacturing a candle.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of one embodiment of a candle including a candle body and a candle wick having features of the present invention;

FIG. 2A is an exploded side view of the candle wick illustrated in FIG. 1;

FIG. 2B is a simplified top view of the candle wick illustrated in FIG. 1;

FIG. 2C is an alternative simplified top view of the candle wick;

FIG. 3A is an exploded side view of another embodiment of the candle wick;

FIG. 3B is a simplified side view of the candle wick illustrated in FIG. 3A;

FIG. 3C is a simplified top view of the candle wick illustrated in FIG. 3A;

FIG. 4A is an exploded side view of yet another embodiment of the candle wick;

FIG. 4B is a simplified side view of the candle wick illustrated in FIG. 4A;

FIG. 4C is a simplified top view of the candle wick illustrated in FIG. 4A;

FIG. 5A is an exploded side view of still another embodiment of the candle wick;

FIG. 5B is a simplified side view of the candle wick illustrated in FIG. 5A;

FIG. 5C is a simplified top view of the candle wick illustrated in FIG. 5A;

FIG. 6A is an exploded side view of but another embodiment of the candle wick;

FIG. 6B is a simplified top view of the candle wick illustrated in FIG. 6A;

FIG. 7A is an exploded side view of another embodiment of the candle wick;

FIG. 7B is a simplified top view of the candle wick illustrated in FIG. 7A;

FIG. 8A is an exploded side view of yet another embodiment of the candle wick;

FIG. 8B is a simplified top view of the candle wick illustrated in FIG. 8A;

FIG. 8C is an alternative simplified top view of the candle wick illustrated in FIG. 8A;

FIG. 9A is an exploded side view of another embodiment of the candle wick;

FIG. 9B is a simplified top view of the candle wick illustrated in FIG. 9A;

FIG. 9C is a simplified side perspective view of the candle wick illustrated in FIG. 9A;

FIG. 10A is an exploded side view of still another embodiment of the candle wick;

FIG. 10B is a simplified top view of the candle wick illustrated in FIG. 10A;

FIG. 10C is a simplified side perspective view of the candle wick illustrated in FIG. 10A;

FIG. 11A is an exploded side view of yet another embodiment of the candle wick;

FIG. 11B is a simplified top view of the candle wick illustrated in FIG. 11A;

FIG. 11C is a simplified side perspective view of the candle wick illustrated in FIG. 11A;

FIG. 12A is an exploded side view of still yet another embodiment of the candle wick; and

FIG. 12B is a simplified top view of the candle wick illustrated in FIG. 12A.

### DESCRIPTION

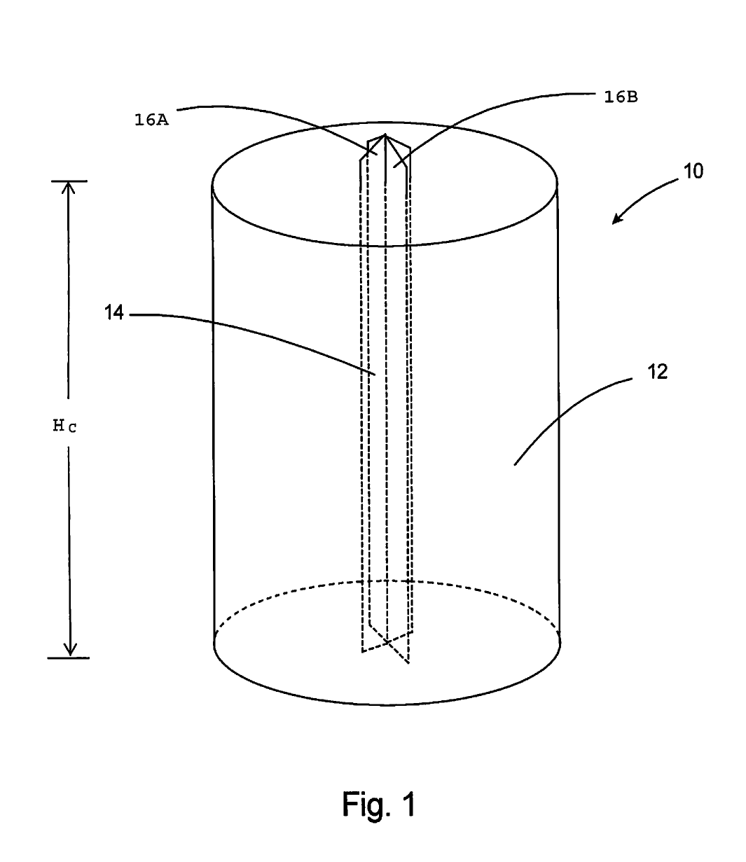

FIG. 1 is a perspective view of an embodiment of a candle 10 having features of the present invention. The design of the candle 10 can be varied. As illustrated, the candle 10 can include a candle body 12 and a candle wick 14 (also sometimes referred to herein simply as a “wick”).

The candle body 12 can be formed into various shapes. For example, as illustrated in FIG. 1, the candle body 12 can have a substantially cylindrical shape with a substantially circular cross-section. Alternatively, the candle body 12 can have any other suitable shape. In certain non-exclusive alternative embodiments, the candle body 12 can have a substantially oval, triangle, rectangle or square shape, or some other geometric or random shape.

Additionally, the candle body 12 can be made and/or formed from various materials that melt when heated. For example, in certain non-exclusive embodiments, the candle body 12 can be made pure hydrocarbons, e.g., paraffin, pure triglycerides, and/or blends using both hydrocarbons and triglycerides. Alternatively, the candle body 12 can be made and/or formed from one or more different materials, such as mineral wax, synthetic wax, vegetable wax, animal wax, or gels.

Further, when in use, the candle body 12 is designed to be supported on a substantially horizontal support surface (not illustrated). In alternative embodiments, the candle body 12 can be used with a candle holder (not illustrated), which can be of various designs, or the candle body 12 can be used without a candle holder. Moreover, the candle body 12 has a height H_{C} that extends substantially perpendicular to the support surface, such that a candle flame extends substantially parallel with the height H_{C} of the candle body 12.

The candle wick 14 is positioned substantially within the candle body 12. In particular, as illustrated in FIG. 1, the wick 14 can be substantially centrally positioned within the candle body 12 and can extend substantially parallel to the height H_{C} of the candle body 12. Alternatively, the wick 14 can be positioned offset from the center of the candle body 12 and/or the wick 14 can extend somewhat at an angle relative to the height H_{C} of the candle body 12.

As illustrated herein, the wick 14 is made up of a plurality of wick members including a first wick member 16A and a second wick member 16B. Alternatively, the wick 14 can include more than two wick members 16A, 16B. Further, as disclosed herein, the wick 14 is selectively movable between a non-working configuration and a working configuration. When in the non-working configuration, the wick members 16A, 16B are not engaging one another, and the wick members 16A, 16B can be conveniently and compactly packaged together for shipping and/or storage. Further, each wick member 16A, 16B has a relatively flat design which enables easier manufacturing of the individual wick members 16A, 16B. Conversely, when in the working configuration, the wick members 16A, 16B engage one another so that the wick members 16A, 16B are coupled together to form the wick 14 having a three-dimensional profile. Stated another way, in this and various other embodiments described herein, the wick members 16A, 16B are engaged in an interlocking manner as illustrated and described herein.

As utilized herein, the wick 14 having a three-dimensional profile means that at least two wick members 16A, 16B engage one another and are positioned at an angle, i.e. are positioned other than parallel, relative to one another. For example, as illustrated in FIG. 1, when in the working configuration, the first wick member 16A is positioned at an angle, e.g., approximately 90 degrees in this example, relative to the second wick member 16B. With this design, the wick 14 can produce a more robust and durable flame that is stable even through relatively long burn cycles. Additionally, the three-dimensional structure of the wick 14 can allow for greater design flexibility for a designer of the candle, thereby permitting the candle designer to exhibit more control over the flame configuration. For example, the three-dimensional structure of the wick 14 can include various shapes and designs, several of which are demonstrated herein below.

Additionally, in the working configuration, the wick members 16A, 16B can intersect with or engage one another at right angles, e.g., as illustrated in FIG. 1. However, other angles may be employed to provide even greater creative freedom to the candle designer.

Further, while the wick 14 illustrated in FIG. 1 exhibits a fairly consistent cross-sectional profile from top to bottom, i.e. throughout the height of the candle 10 and the height H_{C} of the candle body 12, the wick 14 can include various differing cross-sectional profiles from top to bottom of the candle 10.

In certain embodiments, the wick 14 and the wick members 16A, 16B can be made to include a wide variety of wood types. In certain non-exclusive embodiments, the wick 14 can consist of one or more of the following wood types: basswood, balsa, cedar, bamboo, heart pine and red oak. Alternatively, the wick 14 can utilize other suitable types of wood. Additionally, although the wick 14 as illustrated herein is described as being comprised of one or more wood materials, such embodiments are not intended to be limiting in any way, and the wick 14 can additionally and/or alternatively include one or more non-wood materials. As used herein, the term “wood material” is intended to refer to a particular type of wood, e.g., wood from a particular type of tree, or a specific type of composite wood material, such as that which is formed from one or more specific types of wood particles, chips or other pieces of wood. Further, in different embodiments, one or more of the wick members 16A, 16B can be made from substantially the same material, and/or one or more of the wick members 16A, 16B can be made from different materials.

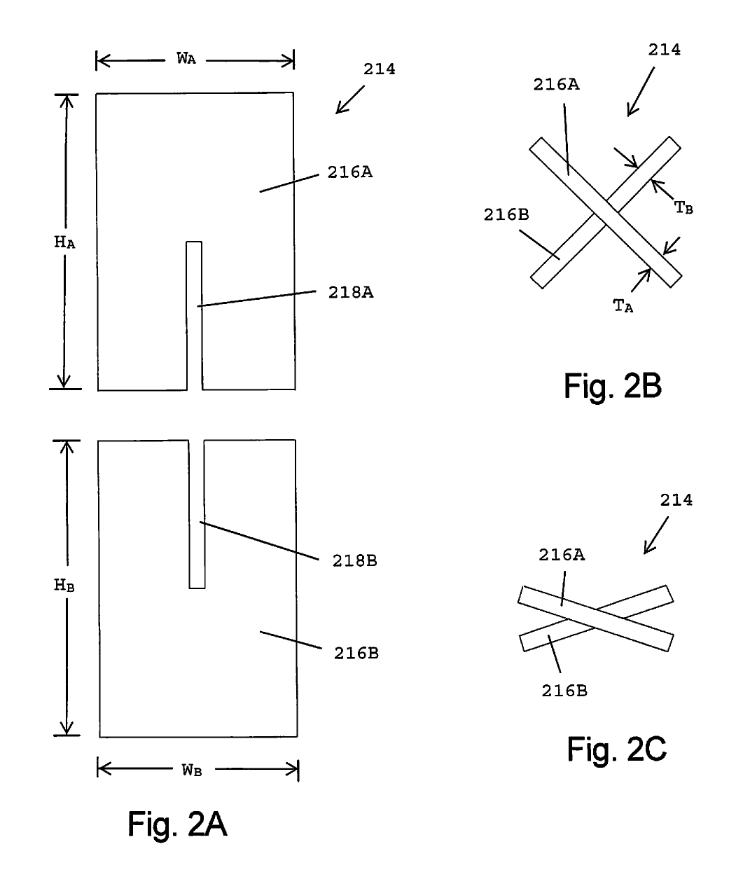

Each wick member 16A, 16B has a thickness T_{A}, T_{B} (for example, as illustrated in FIG. 2B), a width W_{A}, W_{B} (for example, as illustrated in FIG. 2A) and a height H_{A}, H_{B} (for example, as illustrated in FIG. 2A). In certain non-exclusive embodiments, each wick member 16A, 166 can have a thickness T_{A}, T_{B} of between approximately one-thirty-second ( 1/32) inches and one-eighth (⅛) inches and a width W_{A}, W_{B} of between approximately one-quarter (¼) inches and one inch. Further, the height H_{A}, H_{B} of the wick members 16A, 16B is measured in a direction approximately or exactly parallel to the height H_{C} of the candle body 12. Still further, the height H_{A}, H_{B} of the wick members 16A, 16B, and the overall height of the wick 14, is dependent upon the height H_{C} of the candle body 12 with which the wick 14 is used. For example, in one non-exclusive embodiment, the height of the wick 14 when in the working configuration is approximately one-half inch greater than the height H_{C} of the candle body 12, i.e. one-half inch greater than the wax depth. Alternatively, the wick members 16A, 16B can have corresponding thicknesses T_{A}, T_{B}, widths W_{A}, W_{B}, and heights H_{A}, H_{B}, that are different than, i.e. greater than or less than, the dimensions as specifically disclosed herein. Further, the individual components of a single wick 14, i.e. the different wick members 16A, 16B, may differ from one another in thickness, width, height, and/or type of wood or material.

In certain embodiments, one or both of the wick members 16A, 16B includes a slot 218A, 218B, respectively, (e.g., as illustrated in FIG. 2A) that extends at least primarily in a direction that is parallel to the height H_{A}, H_{B} of the wick member 16A, 16B. In one embodiment, the slot 218A, 218B can extend approximately or exactly in a direction that is parallel to the height H_{A}, H_{B} of the wick member 16A, 16B. When in the working configuration, the slots 218A, 218B of the various wick members 16A, 16B engage one another at an angle so that the first wick member 16A engages the second wick member 16B in an interlocking manner to form a wick 14 having a three-dimensional profile. Various embodiments of wicks 14 and/or wick members 16A, 16B, and various three-dimensional profiles created by the engaging of the wick members 16A, 16B, are illustrated and described below in FIGS. 2A-12B.

Further, in some embodiments, the wick members 16A, 16B can be dried and treated prior to use. For example, the wick members 16A, 16B can be dried so that they have a moisture content of between 0 and approximately 6 percent. Alternatively, the wick members 16A, 16B can have a moisture content of between 0 and approximately 4 percent. Still alternatively, the wick members 16A, 16B can have a moisture content of between 0 and approximately 2 percent. In another embodiment, the wick members 16A, 16B can have a moisture content of between 0 and approximately 1 percent. In still another embodiment, the wick members 16A, 168 can have a moisture content of less than 0.5 percent.

Moreover, in one embodiment, the wick members 16A, 16B may be cleaned, dried, treated with a liquid wax and/or cured prior to being used in the candle 10. For example, in one embodiment, the wick members 16A, 16B can be treated with an oil, liquid wax, or molten wax prior to incorporation into the candle 10.

Additionally, the wick members 16A, 16B are joined solely by mechanical means such that no adhesives are required, thereby decreasing the likelihood of leaching of the adhesive into the wax of the candle body 12 with concomitant discoloration or imparting undesired odors to the fragrance of the candle 10 emitted during burning.

FIG. 2A is an exploded side view of an embodiment of a wick 214 usable as part of the candle 10 illustrated in FIG. 1. Stated another way, FIG. 2A is a side view of the wick 214, wherein the wick 214 is in the non-working configuration. As illustrated in this embodiment, the wick 214 includes a first wick member 216A and a second wick member 216B.

The first wick member 216A can be made from a first material. For example, in certain embodiments, the first material can include one or more of basswood; balsa, cedar, bamboo, heart pine, red oak, another suitable wood, or some other suitable material. As shown, the first wick member 216A is substantially rectangle shaped, having a first width W_{A} and a first height H_{A}. Additionally, in this embodiment, the first wick member 216A includes a first slot 218A that can be substantially centrally located along the bottom of the first wick member 216A and that extends in a direction substantially parallel to the first height H_{A} of the first wick member 216A. In one embodiment, the first slot 218A can extend upward from the bottom of the first wick member 216A approximately one-half the first height H_{A} of the first wick member 216A. Alternatively, the first slot 218A can extend greater than or less than one-half the first height H_{A} of the first wick member 216A.

The second wick member 216B can be made from a second material. For example, in certain embodiments, the second material can include one or more of basswood, balsa, cedar, bamboo, heart pine, red oak, some other wood, or some other material. In different embodiments, the second material can be substantially similar or identical to the first material or the second material can be different than the first material. Additionally, as shown, the second wick member 216B is also substantially rectangle shaped, having a second width W_{B} and a second height H_{B}. In this embodiment, the second width W_{B} and a second height H_{B} are approximately equal to the first width W_{B} and a first height H_{B}, respectively. Alternatively, the second width W_{B} can be greater than or less than the first width W_{A} and/or the second height H_{B} can be greater than or less than the first height H_{A}.

Further, the second wick member 216B includes a second slot 218B that can be substantially centrally located along the top of the second wick member 216B and that extends in a direction substantially parallel to the second height H_{B} of the second wick member 216B. In one embodiment, the second slot 218B can extend downward from the top of the second wick member 216B approximately one-half the second height H_{B} of the second wick member 216B. Alternatively, the second slot 218B can extend greater than or less than one-half the second height H_{B} of the second wick member 216B.

Additionally, in certain embodiments, the length of the first slot 218A plus the length of the second slot 218B can be substantially equal to the first height H_{A} of the first wick member 216A and/or substantially equal to the second height H_{B} of the second wick member 216B. Alternatively, the length of the first slot 218A plus the length of the second slot 218B can be greater than or less than the first height H_{A} of the first wick member 216A and/or greater than or less than the second height H_{B} of the second wick member 216B.

FIG. 2B is a simplified top view of the wick 214 illustrated in FIG. 2A, wherein the wick 214 is in the working configuration. In this embodiment, and as illustrated in other embodiments, the first slot 218A (illustrated in FIG. 2A) of the first wick member 216A at least partially or fully engages the second slot 218B (illustrated in FIG. 2A) of the second wick member 216B in an interlocking manner, and at an angle relative to one another to form the wick 214 having a three-dimensional profile. As illustrated, the first wick member 216A and the second wick member 216B can cooperate to form the wick 214 having a substantially X-shaped cross-section, when the wick 214 is in the working configuration. In this embodiment, the first wick member 216A and the second wick member 216B are substantially at right angles relative to one another when the wick 214 is in the working configuration. In various embodiments illustrated herein, the first slot 218A aligns and interlocks with the second slot 218B so that the first wick member 216A engages and/or is connected to the second wick member 216B.

Further, as illustrated in FIG. 2B, the first wick member 216A has a first thickness T_{A} and the second wick member 216B has a second thickness T_{B}. In this embodiment, the first thickness T_{A} is approximately equal to the second thickness T_{B}. Alternatively, the first thickness T_{A} can be greater than or less than the second thickness T_{B}.

FIG. 2C is an alternative simplified top view of the wick 214 illustrated in FIG. 2A, wherein the wick 214 is in the working configuration. As illustrated, the first wick member 216A and the second wick member 216B can cooperate to form the wick 214 having a somewhat flattened or distorted X-shaped cross-section, when the wick 214 is in the working configuration. In this embodiment, the first wick member 216A and the second wick member 216B are at something other than right angles relative to one another when the wick 214 is in the working configuration.

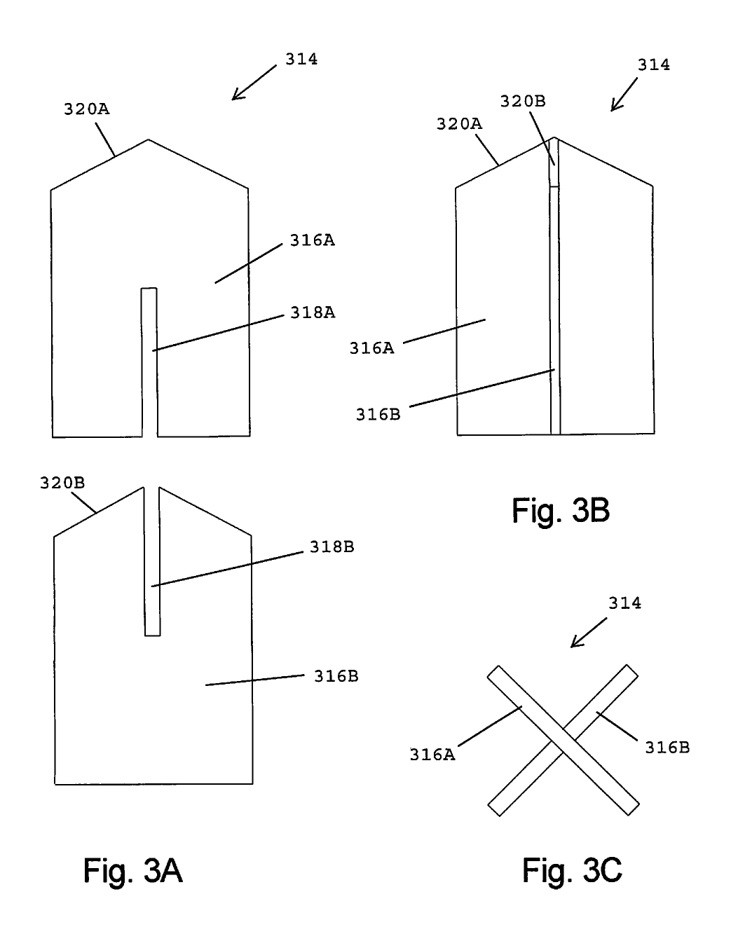

FIG. 3A is an exploded side view of another embodiment of a wick 314 usable as part of the candle 10 illustrated in FIG. 1. Stated another way, FIG. 3A is a side view of the wick 314, wherein the wick 314 is in the non-working configuration. As illustrated in this embodiment, the wick 314 can include a first wick member 316A and a second wick member 316B.

As shown, the first wick member 316A and the second wick member 316B are similar to the first wick member 216A and the second wick member 216B illustrated and described above in relation to FIG. 2A. For example, the first wick member 316A includes a first slot 318A and the second wick member 316B includes a second slot 318B. However, in this embodiment, the first wick member 316A and the second wick member 316B each have an angled top 320A, 320B, respectively, that provides a slightly different profile for the wick 314 when the wick 314 is in the working configuration.

FIG. 3B is a simplified side view of the wick 314 illustrated in FIG. 3A, wherein the wick 314 is in the working configuration. In this embodiment, the first slot 318A (illustrated in FIG. 3A) of the first wick member 316A engages the second slot 318B (illustrated in FIG. 3A) of the second wick member 316B at an angle to form the wick 314 having a three-dimensional profile. In this embodiment, the wick members 316A, 316B can be engaged in an interlocking manner. As illustrated in FIG. 3B, the first wick member 316A and the second wick member 316B can cooperate so that the angled top of the wick 314 is generally pyramid shaped, with the top 320A, 320B of each wick member 316A, 316B sloping at an angle downward from the middle of the top of the wick 314, when the wick 314 is in the working configuration.

FIG. 3C is a simplified top view of the wick 314 illustrated in FIG. 3A, wherein the wick 314 is in the working configuration. As illustrated, the first wick member 316A and the second wick member 316B can cooperate to form the wick 314 having a substantially X-shaped cross-section, when the wick 314 is in the working configuration.

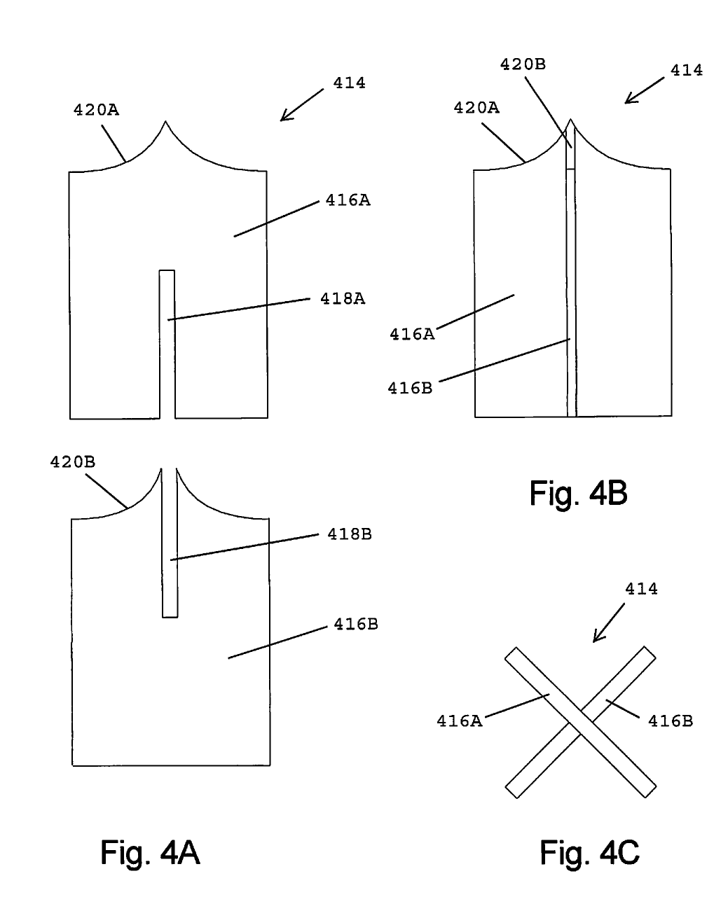

FIG. 4A is an exploded side view of another embodiment of a wick 414 usable as part of the candle 10 illustrated in FIG. 1. As illustrated in this embodiment, the wick 414 can include a first wick member 416A and a second wick member 416B. As shown, the first wick member 416A and the second wick member 416B are substantially similar to the first wick member 216A and the second wick member 216B illustrated and described above in relation to FIG. 2A. For example, the first wick member 416A includes a first slot 418A and the second wick member 416B includes a second slot 418B. However, in this embodiment, the first wick member 416A and the second wick member 416B each have a top 420A, 420B, respectively, with a concave curve that provides a slightly different profile for the wick 414 when the wick 414 is in the working configuration.

FIG. 4B is a simplified side view of the wick 414 illustrated in FIG. 4A, wherein the wick 414 is in the working configuration. In this embodiment, the first slot 418A (illustrated in FIG. 4A) of the first wick member 416A engages the second slot 418B (illustrated in FIG. 4A) of the second wick member 416B at an angle to form the wick 414 having a three-dimensional profile. In this embodiment, the wick members 416A, 416B can be engaged in an interlocking manner. As illustrated, the first wick member 416A and the second wick member 416B can cooperate so that the top of the wick 414 is somewhat pyramid shaped, with the top 420A, 420B of each wick member 416A, 416B having a concave slope extending downward from the middle of the top of the wick 414, when the wick 414 is in the working configuration.

FIG. 4C is a simplified top view of the wick 414 illustrated in FIG. 4A, wherein the wick 414 is in the working configuration. As illustrated, the first wick member 416A and the second wick member 416B can cooperate to form the wick 414 having a substantially X-shaped cross-section, when the wick 414 is in the working configuration.

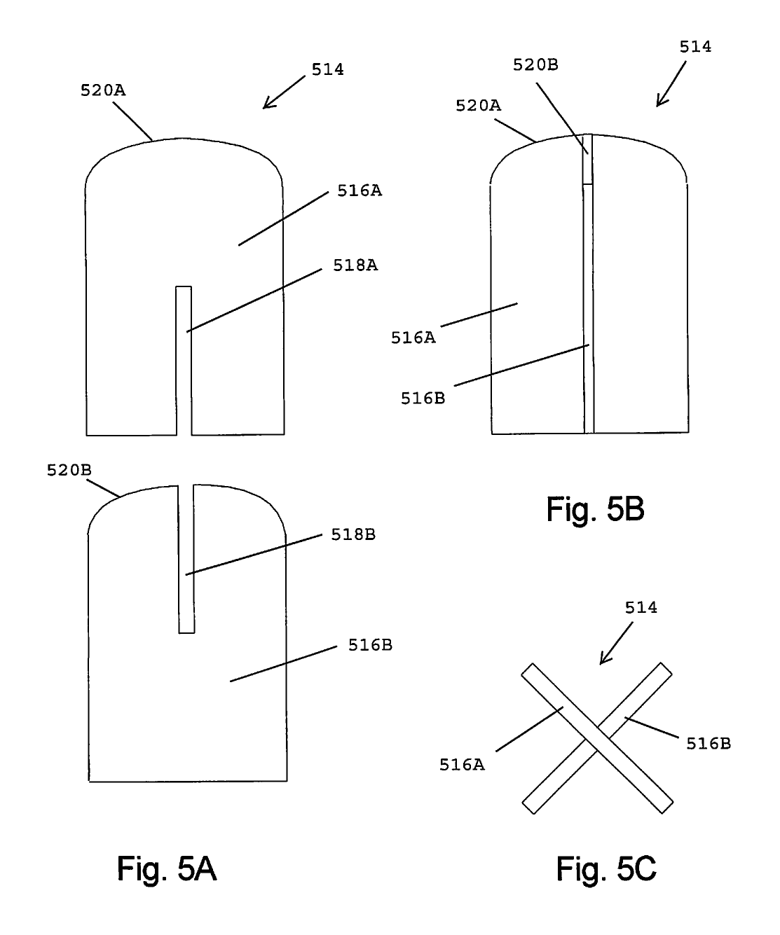

FIG. 5A is an exploded side view of still another embodiment of a wick 514 usable as part of the candle 10 illustrated in FIG. 1. As illustrated in this embodiment, the wick 514 can include a first wick member 516A and a second wick member 516B. As shown in FIG. 5A, the first wick member 516A and the second wick member 516B are similar to the first wick member 216A and the second wick member 216B illustrated and described above in relation to FIG. 2A. For example, the first wick member 516A includes a first slot 518A and the second wick member 516B includes a second slot 518B. However, in this embodiment, the first wick member 516A and the second wick member 516B each have a top 520A, 520B, respectively, with a convex curve that provides a slightly different profile for the wick 514 when the wick 514 is in the working configuration.

FIG. 5B is a simplified side view of the wick 514 illustrated in FIG. 5A, wherein the wick 514 is in the working configuration. In this embodiment, the first slot 518A (illustrated in FIG. 5A) of the first wick member 516A engages the second slot 518B (illustrated in FIG. 5A) of the second wick member 516B at an angle to form the wick 514 having a three-dimensional profile. In this embodiment, the wick members 516A, 516B can be engaged in an interlocking manner. As illustrated, the first wick member 516A and the second wick member 516B can cooperate so that the top of the wick 514 is somewhat pyramid shaped, with the top 520A, 520B of each wick member 516A, 516B having a concave slope extending downward from the middle of the top of the wick 514, when the wick 514 is in the working configuration.

FIG. 5C is a simplified top view of the wick 514 illustrated in FIG. 5A, wherein the wick 514 is in the working configuration. As illustrated, the first wick member 516A and the second wick member 516B can cooperate to form the wick 514 having a substantially X-shaped cross-section, when the wick 514 is in the working configuration.

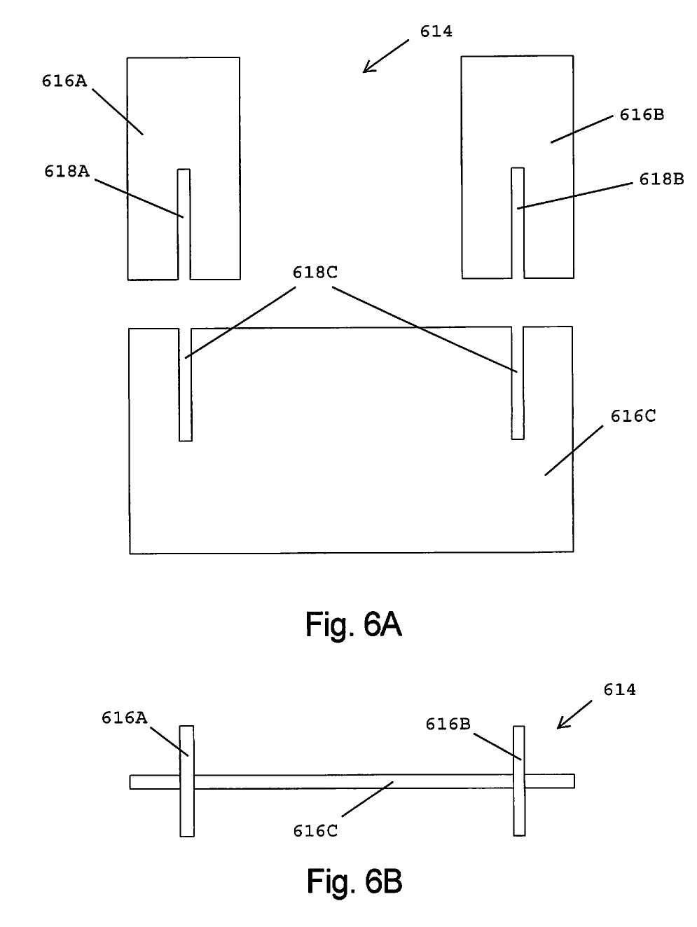

FIG. 6A is an exploded side view of yet another embodiment of a wick 614 usable as part of the candle 10 illustrated in FIG. 1. As illustrated in this embodiment, the wick 614 can include a first wick member 616A, a second wick member 6166 and a third wick member 616C. As shown in FIG. 6A, the first wick member 616A and the second wick member 616B are substantially identical. For example, each of the first wick member 616A and the second wick member 616B is substantially rectangle shaped, and includes a slot 618A, 6186. More particularly, the first wick member 616A includes a first slot 618A and the second wick member 616B includes a second slot 618B. The first slot 618A and the second slot 618B are substantially centrally located along the bottom of the first wick member 616A and the second wick member 616B, respectively, and extend upward substantially parallel to and approximately one-half the height of the first wick member 616A and the second wick member 616B, respectively. Alternatively, the first slot 618A and the second slot 618B can be positioned differently and/or can extend in a different direction or to a different height.

Additionally, the third wick member 616C is substantially rectangle shaped, and includes a pair of third slots 618C that extend in a direction substantially parallel to the height of, the third wick member 616C. In one embodiment, each of the third slots 618C can be positioned near a side of the third wick member 616C and can extend downward from the top of the third wick member 616C approximately one-half the height of the third wick member 616C. Alternatively, the third slots 618C can extend greater than or less than one-half the height of the third wick member 616C.

FIG. 6B is a simplified top view of the wick 614 illustrated in FIG. 6A, wherein the wick 614 is in the working configuration. In this embodiment, the first slot 618A (illustrated in FIG. BA) of the first wick member 616A engages one of the third slots 618C (illustrated in FIG. 6A) of the third wick member 616C at an angle and the second slot 618B (illustrated in FIG. 6A) of the second wick member 616B engages the other third slot 618C (illustrated in FIG. 6A) of the third wick member 616C at an angle, to form the wick 614 having a three-dimensional profile. In this embodiment, two or more of the wick members 616A, 616B, 616C can be engaged in an interlocking manner. As illustrated, the first wick member 616A, the second wick member 616B and the third wick member 616C can cooperate to form the wick 614 having a somewhat H-shaped cross-section, when the wick 614 is in the working configuration.

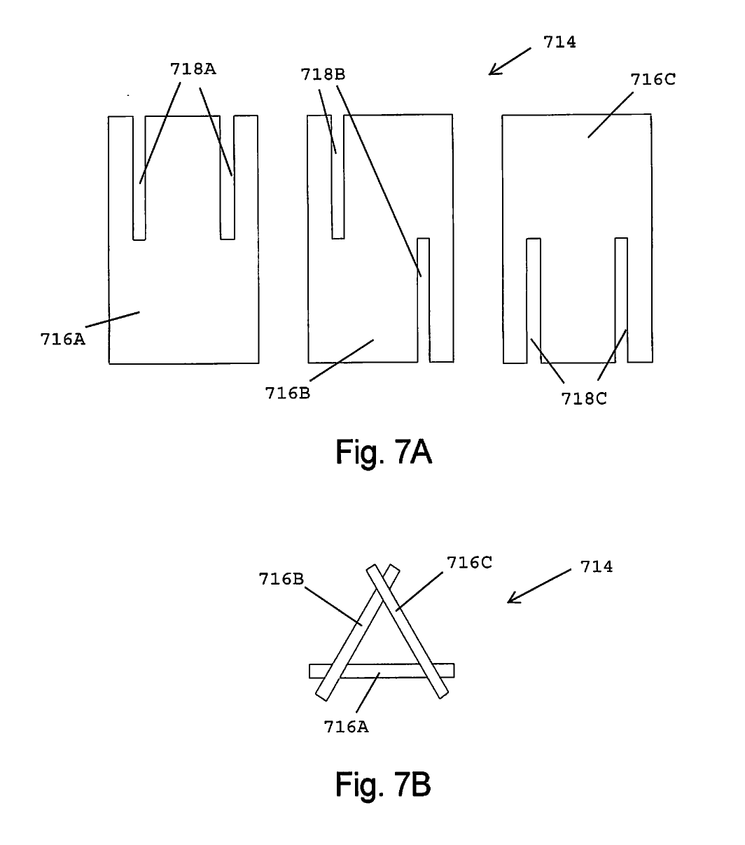

FIG. 7A is an exploded side view of still another embodiment of a wick 714 usable as part of the candle 10 illustrated in FIG. 1. As illustrated in this embodiment, the wick 714 can include a first wick member 716A, a second wick member 716B and a third wick member 716C. As shown in FIG. 7A, each of the wick members 716A, 7166, 716C is substantially rectangle shaped and includes a pair of slots 718A, 718B, 718C, respectively. More particularly, the first wick member 716A includes a pair of first slots 718A, the second wick member 7166 includes a pair of second slots 718B, and the third wick member 716C includes a pair of third slots 718C.

In one embodiment, each of the first slots 718A can be positioned near a side of the first wick member 716A and extend downward from the top of the first wick member 716A approximately one-half the height of the first wick member 716A. Alternatively, the first slots 718A can extend greater than or less than one-half the height of the first wick member 716A.

Additionally, in one embodiment, each of the second slots 718B can be positioned near a side of the second wick member 716B, with one second slot 718B extending downward from the top of the second wick member 716B approximately one-half the height of the second wick member 716B, and the other second slot 718B extending upward from the bottom of the second wick member 716B approximately one-half the height of the second wick member 716B. Alternatively, the second slots 718B can extend greater than or less than one-half the height of the second wick member 716B.

Further, in one embodiment, each of the third slots 718C can be positioned near a side of the third wick member 716C and extend upward from the bottom of the third wick member 716C approximately one-half the height of the third wick member 716C. Alternatively, the third slots 718C can extend greater than or less than one-half the height of the third wick member 716C.

FIG. 7B is a simplified top view of the wick 714 illustrated in FIG. 7A, wherein the wick 714 is in the working configuration. In this embodiment, (i) one of the first slots 718A (illustrated in FIG. 7A) of the first wick member 716A engages one of the second slots 718B (illustrated in FIG. 7A) of the second wick member 716B at an angle and the other first slot 718A engages one of the third slots 718C (illustrated in FIG. 7A) of the third wick member 716C at an angle; (ii) one of the second slots 718B is designed to engage one of the first slots 718A and the other second slot 718B engages one of the third slots 718C at an angle; and (iii) one of the third slots 718C engages one of the first slots 718A at an angle and the other third slot 718C engages one of the second slots 718B at an angle, to form the wick 714 having a three-dimensional profile. In this embodiment, two or more of the wick members 716A, 716B, 716C can be engaged in an interlocking manner. As illustrated, the first wick member 716A, the second wick member 716B and the third wick member 716C can cooperate to form the wick 714 having a substantially triangle shaped cross-section, when the wick 714 is in the working configuration.

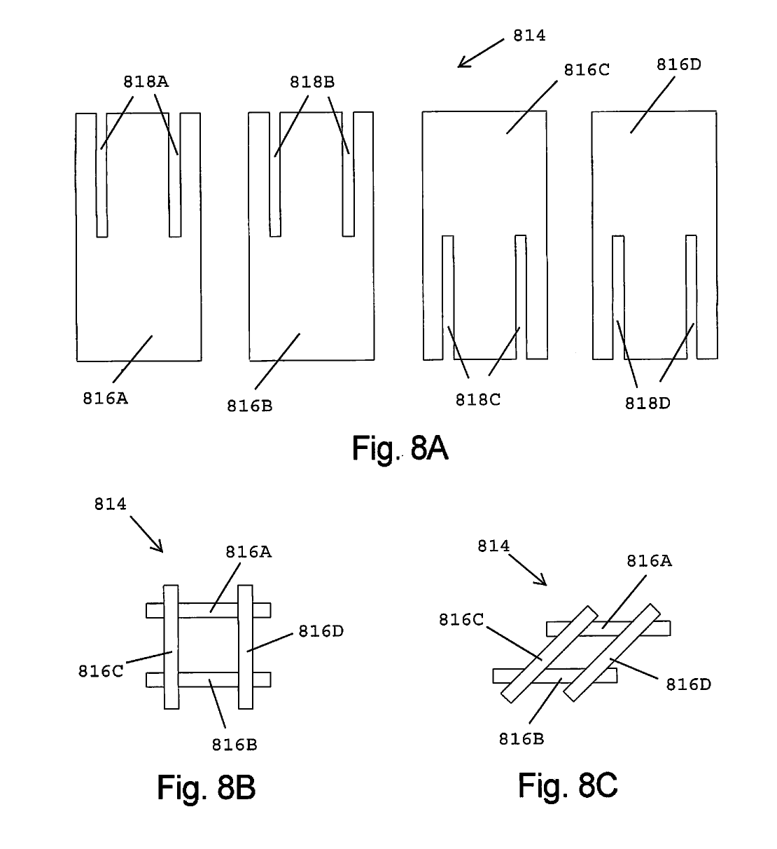

FIG. 8A is an exploded side view of yet another embodiment of a wick 814 usable as part of the candle 10 illustrated in FIG. 1. As illustrated in this embodiment, the wick 814 can include a first wick member 816A, a second wick member 816B, a third wick member 816C and a fourth wick member 816D. In this embodiment, the first wick member 816A and the second wick member 816B can be substantially identical, and the third wick member 816C and the fourth wick member 816D can be substantially identical. As shown in FIG. 8A, each of the first wick member 816A and the second wick member 816B are substantially rectangle shaped and include a pair of slots 818A, 818B, respectively. More particularly, the first wick member 816A includes a pair of first slots 818A and the second wick member 816B includes a pair of second slots 818B.

In one embodiment, each of the first slots 818A can be positioned near a side of the first wick member 816A and extend downward from the top of the first wick member 816A approximately one-half the height of the first wick member 816A. Similarly, each of the second slots 818B can be positioned near a side of the second wick member 816B and extend downward from the top of the second wick member 816B approximately one-half the height of the second wick member 816B. Alternatively, the first slots 818A can extend greater than or less than one-half the height of the first wick member 816A and the second slots 818B can extend greater than or less than one-half the height of the second wick member 816B.

Additionally, as illustrated in FIG. 8A, each of the third wick member 816C and the fourth wick member 816D are substantially rectangle shaped and include a pair of slots 818C, 818D, respectively. More particularly, the third wick member 816C includes a pair of third slots 818C and the fourth wick member 816D includes a pair of fourth slots 818D.

In one embodiment, each of the third slots 818C can be positioned near a side of the third wick member 816C and extend upward from the bottom of the third wick member 816C approximately one-half the height of the third wick member 816C. Similarly, each of the fourth slots 818D can be positioned near a side of the fourth wick member 816D and extend upward from the bottom of the fourth wick member 816D approximately one-half the height of the fourth wick member 816D. Alternatively, the third slots 818C can extend greater than or less than one-half the height of the third wick member 816C and the fourth slots 818D can extend greater than or less than one-half the height of the fourth wick member 816D.

FIG. 8B is a simplified top view of the wick 814 illustrated in FIG. 8A, wherein the wick 814 is in the working configuration. In this embodiment, (i) one of the first slots 818A (illustrated in FIG. 8A) of the first wick member 816A engages one of the third slots 818C (illustrated in FIG. 8A) of the third wick member 816C at an angle and the other first slot 818A engages one of the fourth slots 818D (illustrated in FIG. 8A) of the fourth wick member 816D at an angle; (ii) one of the second slots 818B (illustrated in FIG. 8A) of the second wick member 816B engages one of the third slots 818C at an angle and the other second slot 818B engages one of the fourth slots 818D at an angle; (iii) one of the third slots 818C engages one of the first slots 818A at an angle and the other third slot 818C engages one of the second slots 8186 at an angle; and (iv) one of the fourth slots 818D engages one of the first slots 818A at an angle and the other fourth slot 818D engages one of the second slots 818B at an angle, to form the wick 814 having a three-dimensional profile. In this embodiment, two or more of the wick members 816A, 816B, 816C, 816D can be engaged in an interlocking manner. As illustrated, the first wick member 816A, the second wick member 816B, the third wick member 816C and the fourth wick member 816D can cooperate to form the wick 814 having a lattice shaped or tic-tac-toe cross-section, when the wick 814 is in the working configuration.

FIG. 8C is an alternative simplified top view of the wick 814 illustrated in FIG. 8A, wherein the wick 814 is in the working configuration. As illustrated, the first wick member 816A the second wick member 816B, the third wick member 816C and the fourth wick member 816D can cooperate to form the wick 814 having a somewhat flattened or distorted lattice shaped or tic-tac-toe cross-section, when the wick 814 is in the working configuration. In this embodiment, the first wick member 816A the second wick member 816B, the third wick member 816C and the fourth wick member 816D are at other than right angles relative to one another when the wick 814 is in the working configuration.

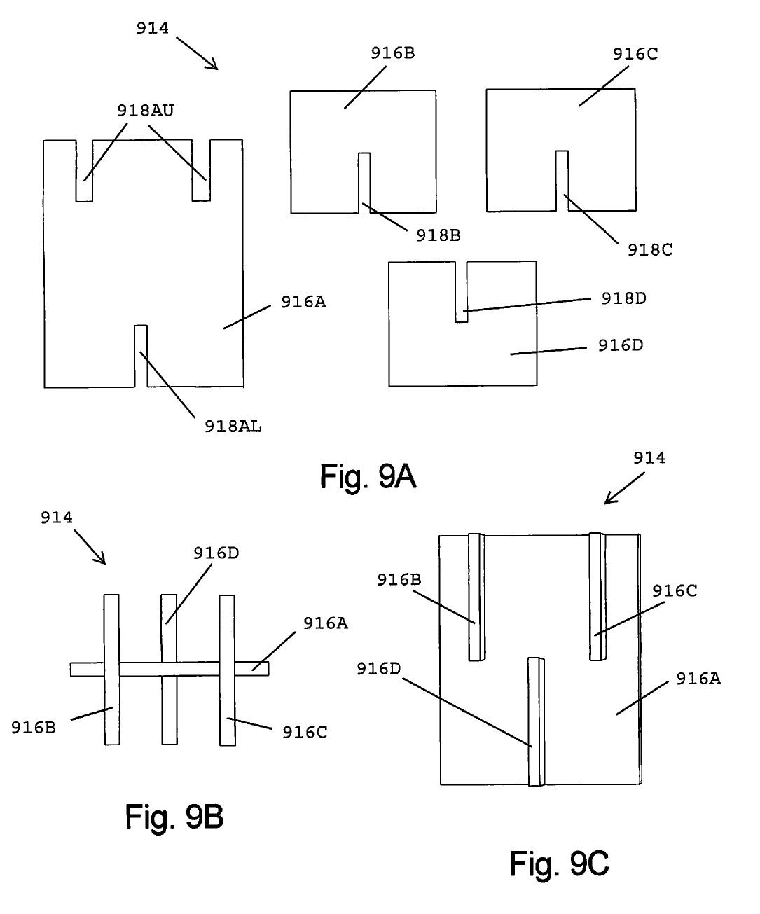

FIG. 9A is an exploded side view of another embodiment of a wick 914 usable as part of the candle 10 illustrated in FIG. 1. As illustrated in this embodiment, the wick 914 can include a first wick member 916A, a second wick member 916B, a third wick member 916C and a fourth wick member 916D. As shown in FIG. 9A, the first wick member 916A is substantially rectangle shaped, and includes a pair of upper first slots 918AU and a lower first slot 918AL that extend in a direction substantially parallel to the height of the first wick member 916A. In one embodiment, the pair of upper first slots 918AU can be positioned near a side of the first wick member 916A and can extend downward from the top of the first wick member 916A approximately one-quarter the height of the first wick member 916A. Further, the lower first slot 918AL can be substantially centrally located along the bottom of the first wick member 916A and can extend upward from the bottom of the first wick member 916A approximately one-quarter the height of the first wick member 916A. Alternatively, one or more of the upper first slots 918AU and the lower first slot 918AL can extend greater than or less than one-quarter the height of the first wick member 916A.

Additionally, as shown in FIG. 9A, the second wick member 916B and the third wick member 916C are substantially identical. Each of the second wick member 916B and the third wick member 916C are substantially rectangle shaped and include a slot 918B, 918C, respectively. More particularly, the second wick member 916B includes a second slot 918B and the third wick member 916C includes a third slot 918C. In one embodiment, the second wick member 916B and the third wick member 916C are approximately one-half the height of the first wick member 916A. Alternatively, the second wick member 9168 and the third wick member 916C can be greater than or less than one-half the height of the first wick member 916A.

Further, in one embodiment, the second slot 918B can be substantially centrally located along the bottom of the second wick member 9168 and extend upward from the bottom of the second wick member 916B approximately one-half the height of the second wick member 916B. Similarly, the third slot 918C can be substantially centrally located along the bottom of the third wick member 916C and extend upward from the bottom of the third wick member 916C approximately one-half the height of the third wick member 916C. Alternatively, the second slot 918B can extend greater than or less than one-half the height of the second wick member 916B and the third slot 918C can extend greater than or less than one-half the height of the third wick member 916C.

Still further, as shown in FIG. 9A, the fourth wick member 916D is substantially rectangle shaped and includes a fourth slot 918D. In one embodiment, the fourth wick member 916D is approximately the same height as the second wick member 916B and the third wick member 916C and is approximately one-half the height of the first wick member 916A. Alternatively, the height of the fourth wick member 916D can be greater than or less than the height of the second wick member 916B and the third wick member 916C, and/or the fourth wick member 916D can be greater than or less than one-half the height of the first wick member 916A.

Moreover, in one embodiment, the fourth slot 918D can be substantially centrally located along the top of the fourth wick member 916D and extend downward from the top of the fourth wick member 916D approximately one-half the height of the fourth wick member 916D. Alternatively, the fourth slot 918D can extend greater than or less than one-half the height of the fourth wick member 916D.

FIG. 9B is a simplified top view of the wick 914 illustrated in FIG. 9A, wherein the wick 914 is in the working configuration. In this embodiment, (i) one of the upper first slots 918AU (illustrated in FIG. 9A) of the first wick member 916A engages the second slot 918B (illustrated in FIG. 9A) of the second wick member 916B at an angle and the other upper first slot 918AU engages the third slot 918C (illustrated in FIG. 9A) of the third wick member 916C at an angle; and (ii) the lower first slot 918AL (illustrated in FIG. 9A) of the first wick member 916A engages the fourth slot 918D (illustrated in FIG. 9A) of the fourth wick member 9160 at an angle, to form the wick 914 having a three-dimensional profile. In this embodiment, two or more of the wick members 916A, 916B, 916C, 916D can be engaged in an interlocking manner. As illustrated, the first wick member 916A, the second wick member 916B, the third wick member 916C and the fourth wick member 916D can cooperate to form the wick 914 having a cross-sectional shape similar to that of a portion of a picket fence, when the wick 914 is in the working configuration.

FIG. 9C is a simplified side perspective view of the wick 914 illustrated in FIG. 9A, wherein the wick 914 is in the working configuration. As illustrated, when the wick 914 is in the working configuration, the second wick member 916B and the third wick member 916C extend substantially perpendicularly away from the first wick member 916A near opposite sides of the first wick member 916A and adjacent to the top half of the first wick member 916A. Further, when the wick 914 is in the working configuration, the fourth wick member 916D extends substantially perpendicularly away from the center of the first wick member 916A adjacent to the bottom half of the first wick member 916A. Alternatively, the second wick member 916B, the third wick member 916C and the fourth wick member 916D can extend other than substantially perpendicularly away from the first wick member 916A.

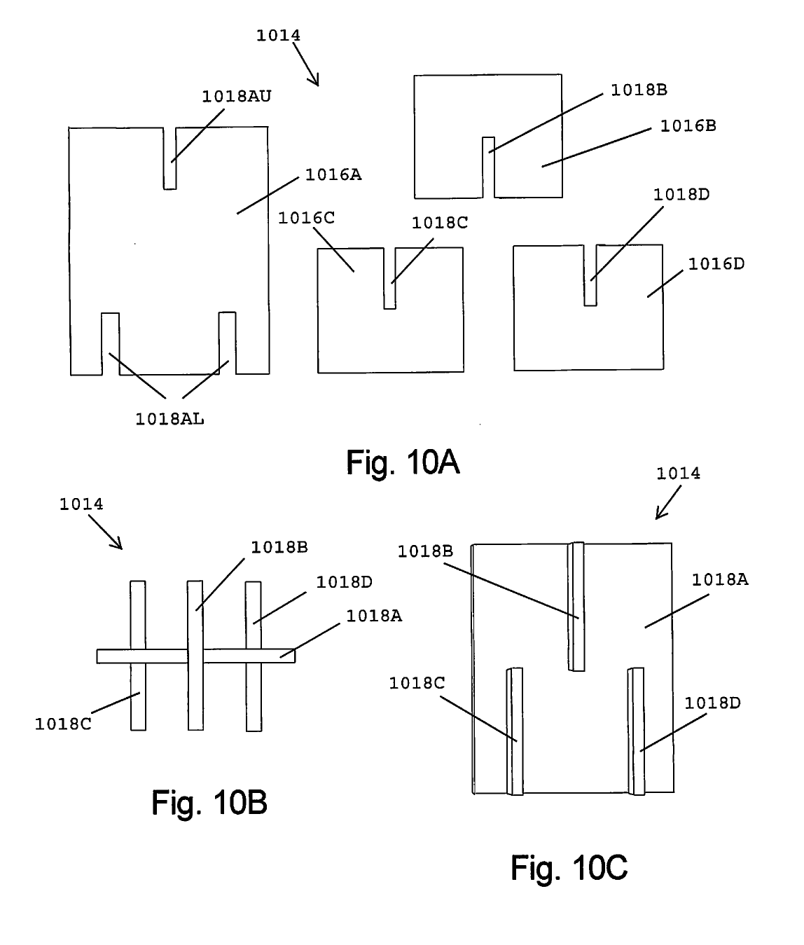

FIG. 10A is an exploded side view of still another embodiment of a wick 1014 usable as part of the candle 10 illustrated in FIG. 1. As illustrated in this embodiment, the wick 1014 can include a first wick member 1016A, a second wick member 1016B, a third wick member 1016C and a fourth wick member 1016D. As shown, the first wick member 1016A is substantially rectangle shaped, and includes a pair of lower first slots 1018AL and an upper first slot 1018AU that extend in a direction substantially parallel to the height of the first wick member 1016A. In one embodiment, the pair of lower first slots 1018AL can be positioned near a side of the first wick member 1016A and can extend upward from the bottom of the first wick member 1016A approximately one-quarter the height of the first wick member 1016A. Further, the upper first slot 1018AU can be substantially centrally located along the top of the first wick member 1016A and can extend downward from the top of the first wick member 1016A approximately one-quarter the height of the first wick member 1016A. Alternatively, one or more of the lower first slots 1018AL and the upper first slot 1018AU can extend greater than or less than one-quarter the height of the first wick member 1016A.

Additionally, as shown in FIG. 10A, the second wick member 10168 is substantially rectangle shaped and includes a second slot 1018B. In one embodiment, the second wick member 1016B is approximately one-half the height of the first wick member 1016A. Alternatively, the second wick member 1.016B can be greater than or less than one-half the height of the first wick member 1016A.

Moreover, in one embodiment, the second slot 1018B can be substantially centrally located along the bottom of the second wick member 1016B and extend upward from the bottom of the second wick member 1016B approximately one-half the height of the second wick member 1016B. Alternatively, the second slot 1018B can extend greater than or less than one-half the height of the second wick member 1016B.

Further, as shown in FIG. 10A, the third wick member 1016C and the fourth wick member 10160 are substantially identical. Each of the third wick member 1016C and the fourth wick member 1016D are substantially rectangle shaped and include a slot 1018C, 1018D, respectively. More particularly, the third wick member 1016C includes a third slot 1018C and the fourth wick member 1016D includes a fourth slot 1018D. In one embodiment, the third wick member 1016C and the fourth wick member 1016D are approximately the same height as the second wick member 1016B and are approximately one-half the height of the first wick member 1016A. Alternatively, the height of the third wick member 1016C and the fourth wick member 1016D can be greater than or less than the height of the second wick member 1016B, and/or the third wick member 1016C and the fourth wick member 1016D can be greater than or less than one-half the height of the first wick member 1016A.

Still further, in one embodiment, the third slot 1018C can be substantially centrally located along the top of the third wick member 1016C and extend downward from the top of the third wick member 1016C approximately one-half the height of the third wick member 1016C. Similarly, the fourth slot 1018D can be substantially centrally located along the top of the fourth wick member 1016D and extend downward from the top of the fourth wick member 1016D approximately one-half the height of the fourth wick member 1016D. Alternatively, the third slot 1018C can extend greater than or less than one-half the height of the third wick member 1016C and the fourth slot 1018D can extend greater than or less than one-half the height of the fourth wick member 1016D.

FIG. 10B is a simplified top view of the wick 1014 illustrated in FIG. 10A, wherein the wick 1014 is in the working configuration. In this embodiment, (i) one of the lower first slots 1018AL (illustrated in FIG. 10A) of the first wick member 1016A engages the third slot 1018C (illustrated in FIG. 10A) of the third wick member 1016C at an angle and the other lower first slot 1018AL engages the fourth slot 1018D (illustrated in FIG. 10A) of the fourth wick member 1016D at an angle; and (ii) the upper first slot 1018AU (illustrated in FIG. 10A) of the first wick member 1016A engages the second slot 1018B (illustrated in FIG. 10A) of the second wick member 1016B at an angle, to form the wick 1014 having a three-dimensional profile. In this embodiment, two or more of the wick members 1016A, 1016B, 1016C, 1016D can be engaged in an interlocking manner. As illustrated, the first wick member 1016A, the second wick member 1016D, the third wick member 1016C and the fourth wick member 1016D can cooperate to form the wick 1014 having a cross-sectional shape similar to that of a portion of a picket fence, when the wick 1014 is in the working configuration.

FIG. 10C is a simplified side perspective view of the wick 1014 illustrated in FIG. 10A, wherein the wick 1014 is in the working configuration. As illustrated, when the wick 1014 is in the working configuration, the second wick member 1016B extends substantially perpendicularly away from the center of the first wick member 1016A adjacent to the top half of the first wick member 1016A. Further, when the wick 1014 is in the working configuration, the third wick member 1016C and the fourth wick member 1016D extend substantially perpendicularly away from the first wick member 1016A near opposite sides of the first wick member 1016A and adjacent to the bottom half of the first wick member 1016A. Alternatively, the second wick member 1016B, the third wick member 1016C and the fourth wick member 1016D can extend other than substantially perpendicularly away from the first wick member 1016A.

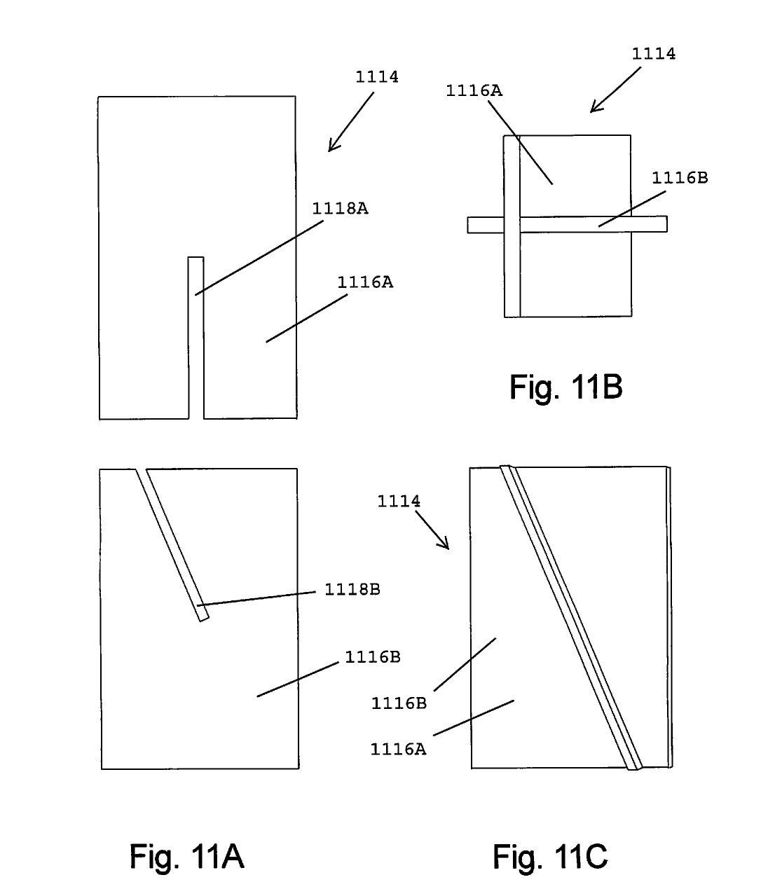

FIG. 11A is an exploded side view of yet another embodiment of a wick 1114 usable as part of the candle 10 illustrated in FIG. 1. As illustrated in this embodiment, the wick 1114 can include a first wick member 1116A and a second wick member 1116B. As shown in FIG. 11A, the first wick member 1116A and the second wick member 1116B are substantially similar to the first wick member 216A and the second wick member 216B illustrated and described above in relation to FIG. 2A. For example, the first wick member 1116A includes a first slot 1118A and the second wick member 1116B includes a second slot 1118B. However, in this embodiment, the second slot 1118B extends at an angle relative to the height of the second wick member 1116B. In one embodiment, the second slot 1118B can extend downward at an angle from the top of the second wick member 1116B approximately one-half the height of the second wick member 1116B. Alternatively, the second slot 1118B can extend greater than or less than one-half the height of the second wick member 1116B. Still alternatively, the second slot 1118B can extend at a different angle relative to the height of the second wick member 11168 than that illustrated in FIG. 11A.

FIG. 11B is a simplified top view of the wick 1114 illustrated in FIG. 11A, wherein the wick 1114 is in the working configuration. In this embodiment, the first slot 1118A (illustrated in FIG. 11A) of the first wick member 1116A engages the second slot 1118B (illustrated in FIG. 11A) of the second wick member 1116B at an angle to form the wick 1114 having a three-dimensional profile. In this embodiment, the wick members 1116A, 1116B can be engaged in an interlocking manner. As illustrated, the first wick member 1116A and the second wick member 1116B can cooperate to form the wick 1114 having a somewhat cross shaped cross-section, when the wick 1114 is in the working configuration.

FIG. 11C is a simplified side perspective view of the wick 1114 illustrated in FIG. 11A, wherein the wick 1114 is in the working configuration. As illustrated, when the wick 1114 is in the working configuration, the second wick member 1116B extends substantially perpendicularly away from the first wick member 1116A and extends downward at an angle relative to the first wick member 1116A from near one side of the first wick member 1116A adjacent to the top of the first wick member 1116A, to near the other side of the first wick member 1116A adjacent to the bottom of the first wick member 1116A. Alternatively, the second wick member 11168 can extend other than substantially perpendicularly away from the first wick member 1116A.

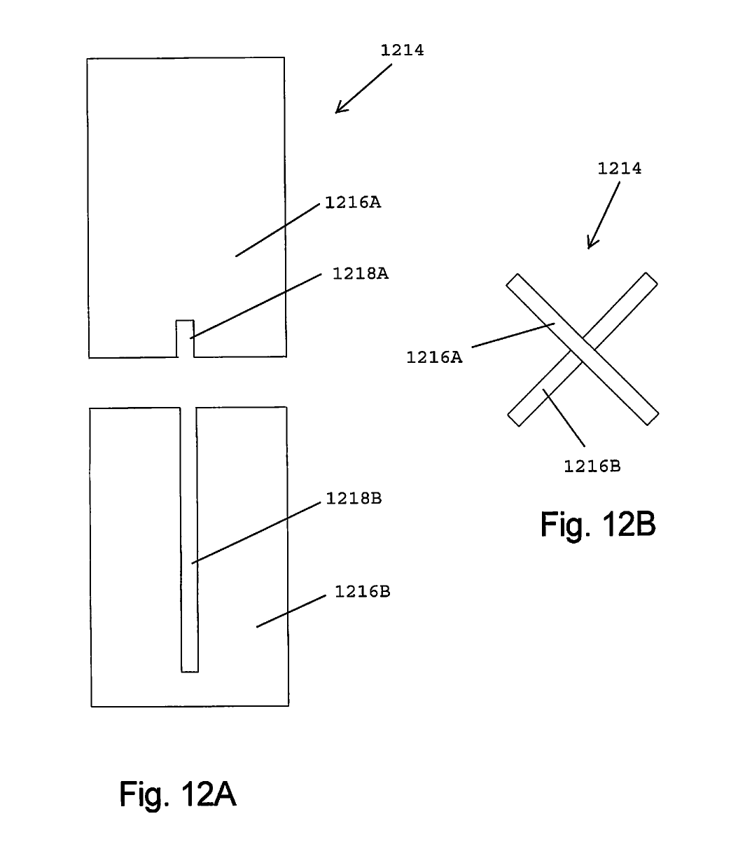

FIG. 12A is an exploded side view of still yet another embodiment of a wick 1214 usable as part of the candle 10 illustrated in FIG. 1. As illustrated in FIG. 12A, in this embodiment, the wick 1214 can include a first wick member 1216A and a second wick member 1216B. As shown in FIG. 12A, the first wick member 1216A and the second wick member 1216B are substantially similar to the first wick member 216A and the second wick member 216B illustrated and described above in relation to FIG. 2A. For example, the first wick member 1216A includes a first slot 1218A and the second wick member 1216B includes a second slot 1218B. However, in this embodiment, the first slot 1218A extends upward from the bottom of the first wick member 1216A approximately one-eighth the height of the first wick member 1216A. Additionally, in this embodiment, the second slot 1218B extends downward from the top of the second wick member 1216B approximately seven-eights the height of the second wick member 1216B. Alternatively, the first slot 1218A can extend greater than or less than one-eighth the height of the first wick member 1216A, and/or the second slot 1218B can extend greater than or less than seven-eights the height of the second wick member 1216B.

FIG. 12B is a simplified top view of the wick 1214 illustrated in FIG. 12A, wherein the wick 1214 is in the working configuration. In this embodiment, the first slot 1218A (illustrated in FIG. 12A) of the first wick member 1216A engages the second slot 1218B (illustrated in FIG. 12A) of the second wick member 1216B at an angle to form the wick 1214 having a three-dimensional profile. In this embodiment, the wick members 1216A, 1216B can be engaged in an interlocking manner. As illustrated, the first wick member 1216A and the second wick member 1216B can cooperate to form the wick 1214 having a substantially X-shaped cross-section, when the wick 1214 is in the working configuration.

It should be noted that the specific designs and features of the various wicks and wick members as illustrated herein can be combined or omitted as desired, and additional features can be added, to allow for greater design flexibility and to provide a greater creative freedom to the candle designer. As such, the specific features of the various wicks and wick members as illustrated herein are not intended to be limiting in any manner other than as provided in the claims.

Moreover, while a number of exemplary aspects and embodiments of the candle wicks have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A candle wick comprising:
a first wick member including a first slot; and
a second wick member including a second slot that is engaged with the first slot so that the second wick member is engaged with the first wick member in an interlocking manner.

2. The candle wick of claim 1 wherein the first wick member is formed from a first wood material and the second wick member is formed from a second wood material.

3. The candle wick of claim 2 wherein the first wood material is substantially similar to the second wood material.

4. The candle wick of claim 2 wherein the first wood material is different than the second wood material.

5. The candle wick of claim 2 wherein the first wick member is engaged at an angle relative to the second wick member.

6. The candle wick of claim 5 wherein the first wick member and the second wick member are positioned at right angles relative to one another.

7. The candle wick of claim 5 wherein the first wick member and the second wick member are positioned at other than right angles relative to one another.

8. The candle wick of claim 2 wherein the first wick member has a first height, and the first slot extends substantially parallel to the first height.

9. The candle wick of claim 2 wherein the second wick member has a second height, and the second slot extends substantially parallel to the second height.

10. The candle wick of claim 2 further comprising a third wick member including a third slot that is engaged at an angle relative to at least one of the first slot and the second slot.

11. The candle wick of claim 10 further comprising a fourth wick member including a fourth slot that is engaged at an angle relative to at least one of the first slot, the second slot and the third slot.

12. A candle including a candle body and the candle wick of claim 1 that is positioned substantially within the candle body.

13. A candle wick comprising:
a first wick member including a first wood material; and
a second wick member including a second wood material, the second wick member being engaged at an angle relative to the first wick member.

14. The candle wick of claim 13 wherein the first wood material is substantially the same as the second wood material.

15. The candle wick of claim 13 wherein the first wood material is different than the second wood material.

16. The candle wick of claim 13 wherein the first wick member includes a first slot and the second wick member includes a second slot, the second slot being engaged at an angle relative to the first slot so that the second wick member is engaged with the first wick member.

17. The candle wick of claim 16 wherein the first wick member has a first height, the first slot extending substantially parallel to the first height, and wherein the second wick member has a second height, the second slot extending substantially parallel to the second height.

18. The candle wick of claim 13 wherein the first wick member and the second wick member are positioned at right angles relative to one another.

19. The candle wick of claim 13 wherein the first wick member and the second wick member are positioned at other than right angles relative to one another.

20. The candle wick of claim 13 further comprising a third wick member including a third wood material, the third wick member being engaged at an angle relative to at least one of the first wick member and the second wick member.

21. The candle wick of claim 20 further comprising a fourth wick member including a fourth wood material, the fourth wick member being engaged at an angle relative to at least one of the first wick member, the second wick member and the third wick member.

22. A candle including a candle body and the candle wick of claim 13 that is positioned substantially within the candle body.

23. A method of manufacturing a candle wick comprising the steps of:
engaging a first slot of a first wick member with a second slot of a second wick member so that the second wick member is engaged with the first wick member.

24. The method of claim 23 wherein the step of engaging include the first wick member including a first wood material and the second wick member including a second wood material.

25. The method of claim 23 wherein the step of engaging includes the step of engaging the first wick member at an angle relative to the second wick member.

26. The method of claim 24 further comprising the step of engaging a third slot of a third wick member at an angle relative to at least one of the first slot and the second slot.

27. The method of claim 26, further comprising the step of engaging a fourth slot of a fourth wick member at an angle relative to at least one of the first slot, the second slot and the third slot.

28. A method of manufacturing a candle including the step of positioning the candle wick manufactured with the method of claim 23 substantially within a candle body.

29. A method of manufacturing a candle wick comprising the step of:
engaging a first wick member at an angle relative to a second wick member, the first wick member including a first wood material and the second wick member including a second wood material.

30. The method of claim 29 wherein the step of engaging includes engaging a first slot of the first wick member at an angle relative to a second slot of the second wick member so that the first wick member is engaged with the second wick member.

31. The method of claim 29 further comprising the step of engaging a third wick member at an angle relative to at least one of the first wick member and the second wick member.

32. The method of claim 31 further comprising the step of engaging a fourth wick member at an angle relative to at least one of the first wick member, the second wick member and the third wick member.

33. A method of manufacturing a candle including the method of manufacturing a candle wick in accordance with claim 29.
